(19) United States
(12) Patent Application Publication
(10) Pub. No.: US 2010/0175443 A1
(43) Pub. Date: Jul. 15, 2010

(54) QUICK DRYING POLYMERIC FERTILIZER ADDITIVE

(75) Inventor: John Larry Sanders, Leawood, KS (US)

Correspondence Address: HOVEY WILLIAMS LLP, 10801 Mastin Blvd., Suite 1000, Overland Park, KS, 66210, US

(73) Assignee: SPECIALTY FERTILIZER PRODUCTS, LLC, Leawood, KS (US)

(21) Appl. No.: 12/351,589

(22) Filed: Jan. 9, 2009

(51) Int. Cl. C05C 11/00; C05C 9/00; C08L 31/00; C08K 5/07; C08K 5/05

(52) U.S. Cl. 71/28; 71/27; 524/559; 524/356; 524/394

(57) ABSTRACT

Improved fertilizer compositions are provided, including a solid nitrogenous fertilizer (e.g., urea) together with a polycarboxylated polymeric adjuvant or additive material selected from the group consisting of a salts of copolymers containing individual quantities of maleic and itaconic moieties. The polymer-containing composition also includes from about 10-60% by weight of an organic compound drying agent such as a lower alcohol which facilitates drying and easy field application of the complete fertilizer composition.

### BACKGROUND OF THE INVENTION

1. Field of the Invention

The present invention is broadly concerned with improved fertilizer compositions and methods wherein the compositions include a solid nitrogenous fertilizer with a polycarboxylated polymer salt adjuvant or additive and a volatile organic drying agent. More particularly, the invention is concerned with such fertilizer compositions and methods wherein a polymer such as a polymaleic acid polymer salt, a polyitaconic acid polymer salt, and a salt of a copolymer containing respective quantities of maleic and itaconic moieties, is supplemented with a volatile drying agent and the resulting polymer-containing composition is mixed with or coated onto solid nitrogenous fertilizer.

2. Description of the Prior Art

U.S. Pat. No. 6,515,090 describes a highly useful class of copolymers which have been employed to good effect in a number of agricultural applications. For example, the '090 patent discloses copolymers made up of varying percentages of maleic and itaconic moieties, and salts thereof, which can be applied to solid fertilizers to achieve surprising increases in yields. In normal practice, an aqueous copolymer mixture is applied by spraying or other means onto solid fertilizers to provide fertilizer-polymer compositions.

However, it has been found that, depending principally upon the moisture content of the solid fertilizer, field application problems with the fertilizer-polymer compositions can arise. In deed, in certain cases relatively wet solid fertilizers with applied aqueous copolymer can create agglomerations within the field application equipment making it difficult or even impossible to evenly spread the compositions across fields.

Mixtures of certain polycarboxylated polymers and organic solvents are known, see U.S. Pat. No. 5,868,964, e.g., polyacrylic acid polymer plus methanol. However, owing to the type of polymer used, and/or the concentration of organic solvent, the polymer and solvent are essentially incompatible, resulting in viscous precipitates unsuitable for use in fertilizer compositions. Polycarboxylate polymer salts do not usually form stable solutions in the presence of significant concentrations of organic solvents such as methanol.

There is accordingly a need in the art for improved fertilizer compositions including solid fertilizer in contact with known fertilizer-enhancing polycarboxylated polymer salts, so as to alleviate the problems experienced with high-moisture solid fertilizers, while at the same time not detracting from the yield benefits obtained using such polymers salts with nitrogenous fertilizers.

### SUMMARY OF THE INVENTION

The present invention overcomes the problems outlined above and provides improved fertilizer compositions, polymer-containing compositions designed for application to solid nitrogenous fertilizers to yield such fertilizer compositions, methods of forming the fertilizer compositions, and methods of fertilizing soil to enhance plant growth using the fertilizer compositions.

In broad outline, the fertilizer compositions of the invention include a quantity of a solid, nitrogenous fertilizer and a polymer-containing composition in contact with the solid fertilizer. The polymer-containing composition as initially formulated and contacted with fertilizer includes a salt of a polycarboxylated polymer selected from the group consisting of a salt of polymaleic acid polymer, a salt of polyitaconic acid polymer, and a salt of a copolymer containing individual quantities of maleic and itaconic moieties, along with a volatile organic drying agent. Thereafter, the drying agent evaporates, along with a substantial part of any water present, so that the fertilizer composition as applied to a field normally does not contain these components to any substantial degree, but rather is made up of the fertilizer plus the residue polymer salt. Surprisingly, it has been found that the selected polymer salts can be mixed with very high concentrations of organic drying agent to produce stable liquid polymer-containing compositions free of the incompatibility problems of the prior art. The final fertilizer composition can be prepared by applying such a polymer-containing composition directly onto the surface of solid fertilizer at levels which enhance the plant growth and yield characteristics of the complete fertilizer compositions, while at the same time causing the vaporization of excess moisture from the fertilizer compositions. This assures that the fertilizer compositions can be field-applied using normal spreaders or the like without the difficulties encountered with prior fertilizer compositions.

The methods of use of the fertilizer compositions involve applying the compositions onto soil adjacent planted seeds or growing plants at normal nitrogen levels.

It has been found that the fertilizer compositions of the invention provide significant increases in crop yields, and that the presence of drying agents does not impede or otherwise effect such yield enhancements.

### DETAILED DESCRIPTION OF THE PREFERRED EMBODIMENTS

The present invention is predicated upon the discovery that solid fertilizer-polymer compositions can be improved through the use of a drying agent forming a part of the polymer-containing composition applied onto solid fertilizers. Such drying agents facilitate and enhance the vaporization of moisture from the compositions, allowing easy field-application thereof.

Virtually any nitrogen-bearing or nitrogenous fertilizer can be improved in accordance with the invention. For example, urea, ammonium nitrate, ammonium sulfate, and mixtures thereof are prime candidates for use in the invention, and can be in any solid form such as prills or granules. The single most preferred solid fertilizer is granular urea.

As indicated above, the polycarboxylated polymers of the invention are broadly selected from the group consisting of a salt of polymaleic acid, a salt of polyitaconic acid, and a salt of a copolymer containing respective quantities of maleic and itaconic moieties. These polymer salts may exist as partial or saturated salts, as well as mixtures of different salts. Virtually any desired cationic species may be used in the formation of the polymeric salts from starting acid polymers, particularly the alkali metals, alkaline earth metals, ammonia, and the alkylamines (e.g., C1-C6 alkylamines such as triethylamine). The polymer salts of the invention are preferably in the form of aqueous dispersions, but non-aqueous organic dispersions may also be used.

Especially preferred polymer salts are the salts of copolymers containing maleic and itaconic moieties. These copolymers are described in U.S. Pat. No. 6,515,090, fully and completely incorporated by reference herein. In general, the copolymer salts should desirably contain from about 10-90% maleic moieties (more preferably from about 25-75%), and correspondingly from about 90-10% itaconic moieties (more preferably from about 75-25%). One particularly preferred copolymer salt of this class is commercialized by Specialty Fertilizer Products, LLC of Leawood, Kans. under the trademark Nutrisphere-N®, which is a 40% solids aqueous copolymer dispersion of substantially equimolar (1:1) amounts of itaconic and maleic anhydride moieties partially neutralized with calcium ion and having a pH of 1-2. More generally, such polymer salts are preferably used as partial or complete salts formed by the addition of a basic material (e.g., calcium hydroxide or sodium hydroxide) to achieve a pH in the range of from about 1-4, more preferably from about 1-3.

The volatile organic drying agent may be made up of one or more organic compounds, and is preferably selected from the group consisting of organic alcohols and ketones, and particularly the C1-C4 alkyl alcohols. For reasons of cost, ease of use and vapor pressure characteristics, methanol is the most preferred drying agent. More broadly, however, the drying agent may be selected from the group consisting of one or more organic compounds having a vapor pressure of at least about 40 mmHg at Standard Temperature and Pressure (STP). This embraces many of the preferred lower alcohols such as methanol (127 mmHg), ethanol (59 mmHg) and isopropanol (42.7 mmHg).

The selected drying agent and polymer salt are preferably mixed together to form a polymer-containing composition designed to be applied to solid nitrogenous fertilizer. In such cases the polymer-containing composition normally comprises the polymer salt dissolved, suspended, or dispersed in a liquid phase comprising water and the drying agent. The drying agent is normally used at a level of from about 10-60% byweight (more preferably about 30-50% by weight, and most preferably about 35-45% by weight) of the complete polymer-containing composition. Use of higher levels of drying agent with the simultaneous presence of high polymer solids concentration may require partial or essentially complete water removal by evaporation or other known means from the starting polymer salt aqueous material. Thus, a preferred polymer-containing composition may include from about 20-70% byweight ofpolymer salt (more preferably from about 30-60% by weight), from about 30-50% byweight drying agent (more preferably from about 35-45% byweight), and from about 10-50% by weight water (more preferably from about 10-25% by weight). An example of such a polymer-containing composition would include about 40% by weight maleic-itaconic copolymer salt, about 45% by weight methanol, and about 15% by weight water, and would have a pH 1-3 and a flash point (as determined by ASTM method D56-05) of 74° F. Generally, the polymeric compositions should have a flash point of greater than 73° F., as determined by the foregoing method.

The polymeric compositions made up of an aqueous polymer salt and drying agent can be applied to solid fertilizer by any convenient means, such as by spraying or dipping. In general, the polymer-containing compositions are applied at a level of from about 0.1-1 gallons of polymer-containing composition per ton of solid fertilizer (more preferably at a level of from about 0.3-0.8 gallons).

Although in preferred forms the drying agent and polymer salt are mixed together to form a polymer-containing composition before application to solid fertilizer, it would be possible to separately apply the polymer salt and drying agent, especially if done substantially simultaneously or in quick succession. In such cases, the rate of application would be the same as that set forth above, considering the makeup of the two different applied substances.

The following example sets forth a preferred polymer-containing composition of the invention and the use thereof on granular urea. It is to be understood, however, that this example is provided by way of illustration and nothing therein should be taken as a limitation upon the overall scope of the invention.

### EXAMPLE

A fertilizer composition was prepared by applying a liquid polymer-containing composition onto granular urea at a rate of ½ gallon of the liquid polymer-containing composition per ton of urea (urea+aqueous-methanol Nutrisphere-N). The polymer-containing composition was made up of approximately 40% by weight of Nutrisphere-N copolymer salt commercialized by Specialty Fertilizer Products of Belton, Mo., approximately 45% by weight methanol and about 15% by weight water. The Nutrisphere-N copolymer salt is a partial calcium salt of a 1:1 maleic-itaconic copolymer.

Another fertilizer composition was prepared using aqueous Nutrisphere-N product applied at the same rate as above onto granular urea, but without the methanol drying agent (urea+aqueous Nutrisphere-N).

A final test fertilizer was straight uncoated urea (uncoated urea).

These three fertilizer compositions were field-tested to determine the effect of the methanol drying agent on yields. This test was conducted in Courtland, Kans. in Crete silt loam soil, pH 6.5, organic matter2.2%, BrayP-one ranging from 19 ppm, soil testpotassium 380 ppm ammonium acetate extractable K. A no-till irrigated corn was planted (May 2) at 32,000 plats/acre on 6 test plots. The planted corn received a fluid fertilizer starter (10-34-0) at a rate of 8 gal. per acre, banded 2×2 beside each row. Sprinkler irritation water was provided from the Lovewell Reservoir in north central Kansas.

The respective solid fertilizer compositions were applied at two rates, 160 and 240 lb. Nitrogen per acre, as a broadcast application immediately after corn planting. The 6 test plots were: uncoated urea/160 b. N/A; urea+aqueous Nutrisphere-N/260 lb. N/A; urea+aqueous-methanol Nutrisphere-N/160 lb. N/A; uncoated urea/240 lb. N/A; urea+aqueous Nutrisphere-N/240 lb. N/A; and urea+aqueous-methanol Nutrisphere-N/240 lb. N/A. There was no incorporation of N into the soil except that which occurred via sprinkler irrigation.

The test plots were harvested November 2 by a plot combine taking the two center rows of each plot. Yield data was reported at 15.5% moisture.

Corn yield responses to the respective solid fertilizers were consistent and highly significant statistically (95% confidence interval). The magnitude of improvement in yield of no-till corn receiving urea+aqueous-methanol Nutrisphere-N versus uncoated urea was similar to that of urea+aqueous Nutrisphere-N polymer (Table 1).

These data indicate that the coating of urea with a high charge density copolymer salt has significant effects upon N use by corn with subsequent increases in corn yield and potential profitability for the grower. These data further confirm that the presence of the drying agent has no deleterious effects upon the performance of the polymer-coated urea.

TABLE
Enhancing N Availability for Irrigated Corn

| Treatments | | Grain Yield |
|---|---|---|
| lb N/A | Form of N | bu/A |
| 160 | Uncoated urea | 173 b* |
| 160 | Urea + Nutrisphere-N | 193 a |
| 160 | Urea + Experimental formulation | 196 a |
| 240 | Uncoated urea | 180 b |
| 240 | Urea + Nutrisphere-N | 196 a |
| 240 | Urea + Experimental formulation | 197 a |
| LSD.05 | | 11 |
| CV % | | 3.8 |

*Means separated by Duncan's multiple range test

1. A fertilizer composition comprising:
a quantity of a solid, nitrogenous fertilizer;
a polymer-containing composition in contact with said solid fertilizer, said polymer-containing composition including a salt of a copolymer containing individual quantities of maleic and itaconic moieties, and an organic compound drying agent.

2. The fertilizer composition of claim 1, said solid fertilizer selected from the group consisting of urea, ammonium nitrate, ammonium sulfate, and mixtures thereof.

3. The fertilizer composition of claim 1, said solid fertilizer being granular.

4. (canceled)

5. The fertilizer composition of claim 1, said copolymer salt containing from about 10-90% maleic moieties, and from about 90-10% itaconic moieties.

6. The fertilizer composition of claim 5, said copolymer salt having about a 1:1 ratio of maleic moieties to itaconic moieties.

7. The fertilizer composition of claim 1, said drying agent selected from the group consisting of organic alcohols and ketones.

8. The fertilizer composition of claim 7, said drying agent selected from the group consisting of C1-C4 alcohols.

9. The fertilizer composition of claim 8, said drying agent being methanol.

10. The fertilizer composition of claim 1, said drying agent selected selected from the group consisting of organic compounds having a vapor pressure of at least about 40 mmHg at STP.

11. The fertilizer composition of claim 1, said polymer-containing composition applied as a surface coating onto said solid fertilizer.

12. The fertilizer composition of claim 1, said polymer-containing composition having a flash point of greater than 73° F.

13. The fertilizer composition of claim 1, said fertilizer composition formed by spraying said polymer-containing composition onto said solid fertilizer.

14. The fertilizer composition of claim 13, said polymer-containing composition comprising a quantity of said copolymer salt suspended in a liquid phase comprising water and said drying agent.

15. The fertilizer composition of claim 14, said drying agent being methanol, and said methanol being present in the fertilizer composition at a level of from about 10-60% by weight.

16. The fertilizer composition of claim 15, said level being of from about 35-45% by weight.

17. The fertilizer composition of claim 14, said polymer-containing composition including from about 20-70% by weight of said copolymer, from about 10-60% by weight methanol, and from about 10-50% by weight water.

18. The fertilizer composition of claim 17, said polymer-containing composition including about 40% by weight of a salt of a maleic-itaconic copolymer, about 45% by weight methanol, and about 15% by weight water.

19. The fertilizer composition of claim 17, said polymer-containing composition being used at a level of from about 0.1-1 gallons of polymer-containing composition per ton of said solid fertilizer.

20. A polymer-containing composition adapted for application to a solid, nitrogenous fertilizer, said polymer-containing composition including a salt of a copolymer containing individual quantities of maleic and itaconic moieties, and an organic compound drying agent.

21. (canceled)

22. The polymer-containing composition of claim 20, said copolymer salt containing from about 10-90% by maleic moieties, and from about 90-10% by itaconic moieties.

23. The polymer-containing composition of claim 22, said copolymer salt having about a 1:1 ratio of maleic moieties to itaconic moieties.

24. The polymer-containing composition of claim 20, said drying agent selected from the group consisting of organic alcohols and ketones.

25. The polymer-containing composition of claim 24, said drying agent selected from the group consisting of C1-C4 alcohols.

26. The polymer-containing composition of claim 25, said polymer-containing composition having a flash point of greater than 73° F.

27. The polymer-containing composition of claim 20, said drying agent selected selected from the group consisting of organic compounds having a vapor pressure of at least about 40 mmHg at STP.

28. A method of forming a fertilizer composition comprising the steps of:
providing a quantity of a solid, nitrogenous fertilizer;
applying a polymer-containing composition onto said solid fertilizer, said polymer-containing composition including a salt of a copolymer containing individual quantities of maleic and itaconic moieties, and an organic compound drying agent.

29. The method of claim 28, said solid fertilizer selected from the group consisting of urea, ammonium nitrate, ammonium sulfate, and mixtures thereof.

30. The method of claim 28, said solid fertilizer being granular.

31. (canceled)

32. The method of claim 28, said copolymer salt containing from about 10-90% by maleic moieties, and from about 90-10% by itaconic moieties.

33. The method of claim 32, said copolymer salt having about a 1:1 ratio of maleic moieties to itaconic moieties.

34. The method of claim 28, said drying agent selected from the group consisting of organic alcohols and ketones.

35. The method of claim 34, said drying agent selected from the group consisting of C1-C4 alcohols.

36. The method of claim 35, said drying agent being methanol.

37. The method of claim 28, said drying agent selected selected from the group consisting of organic compounds having a vapor pressure of at least about 40 mmHg at STP.

38. The method of claim 28, including the step of applying said polymer-containing composition as a surface coating onto said solid fertilizer.

39. The method of claim 38, including the step of spraying said polymer-containing composition onto said solid fertilizer.

40. The method of claim 39, said polymer-containing composition comprising a quantity of said copolymer salt suspended in a liquid phase comprising water and said drying agent.

41. The method of claim 40, said drying agent being methanol, and said methanol being present in the fertilizer composition at a level of from about 10-60% by weight.

42. The method of claim 41, said level being of from about 35-45% by weight.

43. The method of claim 41, said polymer-containing composition including from about 20-70% by weight of said copolymer salt, from about 10-60% by weight methanol, and from about 10-50% by weight water.

44. The method of claim 41, said polymer-containing composition including about 40% by weight of a salt of a maleic-itaconic copolymer salt, about 45% by weight methanol, and about 15% by weight water.

45. The method of claim 41, said polymer-containing composition being used at a level of from about 0.1-1 gallons of polymer-containing composition per ton of said solid fertilizer.

46. The method of claim 28, said polymer-containing composition being aqueous and having a pH of from about 1-4.

47. The polymer-containing composition of claim 20, said polymer-containing composition being aqueous and having a pH of from about 1-4.

48. The fertilizer composition of claim 1, said polymer-containing composition being aqueous and having a pH of from about 1-4.

49. A method of fertilizing soil to enhance plant growth comprising the step of applying a fertilizer composition in accordance with claim 1 onto soil in proximity to planted seeds or growing plants.
